(19) United States
(12) Patent Application Publication
(10) Pub. No.: US 2006/0123681 A1
(43) Pub. Date: Jun. 15, 2006

(54) Equipment for advertisements

(76) Inventor: Andras Gotzy, Budapest (HU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/527,787

(22) PCT Filed: Dec. 6, 2002
(86) PCT No.: PCT/HU02/00137

§ 371 Date: Oct. 14, 2005

(30) Foreign Application Priority Data
Aug. 15, 2002 (HU) P0202711

(51) Int. Cl. G09F 15/00

(52) U.S. Cl. 40/624

(57) ABSTRACT

The advertising board (1; 3; 5; 7; 9; 12; 14; 17; 19) of the equipment and/or its modifying elements (4; 6a-6c; 8; 10; 13; 15; 18; 20) arranged at a distance from this have openings (1a, 1b; 3a; 5a-5c; 7a; 9a; 12a; 14a; 18a, 18b; 19a). For the person approaching the equipment as a consequence of the sensing of the relative movement different advertising elements appear and disappear. Due to this an extremely large number of advertisement variations can be attained, and even the sense of vertical movement can be created.

The invention relates to equipment that is suitable for providing advertisements, especially advertisements alongside public roads, which has an advertising board and a modifying element or elements with it.

It is general knowledge that the significance of the advertising activity is increasing all over the world. Beside the advertisements provided by the media the various advertisements placed in outside spaces play an increasingly greater role. In recent years advertisements, advertising boards placed outside, by busy places (public roads, railways, airports, etc.) have become widespread. The catchy slogans and clever colourful pictures of the advertising boards call people's attention to the subject of the advertisement. In connection with billboards, advertisements that produce movement are more effective because the observer's attention is directed to movements, changes in the environment as a reflex action.

Several types of advertising board that are combined with movement are known. The moving parts of these operate with equipment operated with external energy. The installation and operation of such equipment is very costly, it breaks down easily and is difficult to repair.

Hungarian patent number 217 229 describes equipment for providing advertisements that consists of an advertising board and one or more modifying elements positioned in the space in front of the advertising board. This equipment is based on exploiting a virtual movement effect in such a way that a person moving towards the boards positioned behind one another in a direction that is not perpendicular to them senses movement of the boards with respect to one another and the information expressed with this from the signs and designs displayed on the boards. In spite of its obvious advantages this solution is not able to provide surprising information, as the writing, drawings, designs positioned on the advertising board are only partly covered by the modifying element positioned in front of the board, so a good guess can be made in advance as to what there is on the covered part of the advertising board.

Published Hungarian patent number P 99 01195 describes equipment that provides advertising that is designed to overcome the disadvantage of the solution described above. In the interest of this a modifying board is positioned at a distance behind the advertising board which is at least partly covered by the advertising board from the point of view of a person moving towards it. In this way a person travelling towards the equipment will sense the virtual movement of the modifying element as compared to the advertising board; the sensing of the movement of the modifying element by the moving person is created by the fact that the front-positioned advertising board is closer to him/her. During the apparent movement of the modifying element, its “peering out”, the information on it has a surprising effect on the observer, so this equipment carries out the attention-grabbing function involving a surprise combined with virtual movement well.

However, from certain points of view this latterly described equipment can not be seen as being completely satisfactory, both from the structural and functional points of view. The boards have to be considerably large, which involves a high cost; combined with this is the requirement of a perfect structural solution, from a statics point of view, of the boards set up outside, which is particularly important with the increase of the mass of the boards and may require high extra costs. Reducing the size of the visible surface of the board and so the amount of material built in would, however, lead to the advertising surface becoming lost, which would be to the detriment of the effectiveness of the advertisement. From a functional point of view it may be a problem that the person travelling towards the equipment needs to be moving at a relatively high speed towards it in order to sense the movement. Another disadvantage is that distance of the modifying elements from the advertising board frequently has to be made overly large in order to create the sense of movement, which may involve other disadvantages (for example a large area requirement, the visibility of the supporting structure, the visibility of the concrete number of boards detracting from the surprise factor, etc.). Finally the effectiveness of the advertisement/advertising is restricted to a certain degree by that the known equipment, the fixed advertising boards and modifying elements do not provide the possibility for sensing relative movement in the vertical direction.

The task to be solved with the invention is to provide equipment suitable for displaying advertisements, especially advertisements alongside public roads, which completely retains the advantages of the advertisement-providing equipment described above from the point of view of material-use, structural-statics and cost-effectiveness with a solution more rational than the above and which is able to display advertisements that are more varied and effective, including the creation of the sensing of vertical virtual movement as well.

The invention is based on the following recognitions:

If we make an opening, cut-out, in the advertising board and place the modifying element behind the cut-out, we involve the active surface of the board into the range of movement-perceptibility, which was not possible in the case of the earlier solutions, as it was always the relative movement displayed at the edge or edges of the advertising board that created the advertisement-effect, if the modifying element was positioned behind the board, or if in front of the board then the movement of a complete advertising element, for example a word could be perceived on the surface of the board in a determined direction, without the slightest surprise effect. We recognised that due to the cut-out the human eye senses that the picture on the board, actually on the modifying element behind the cut-out, moves, which derives from the fact that beyond a certain distance the human eye does not see “spatially”, it does not sense the distance between two objects. The eye may be tricked with this cut-out solution, which provides a new, unexpected effect never before experienced. The observer does not see the modifying elements, so he/she is not even able to determine their number as they are in partly covered positions. As the modifying elements are positioned behind the cut-outs near to the advertising board, even a pedestrian observer may sense movement, so it is not absolutely necessary for the persons whom we desire to have an effect on with the advertisement to be travelling in a public road vehicle in order for the advertising effect to be created. The openings reduce the material requirement of the board, which is more favourable from a statics point of view, so making it possible to use a cheaper supporting structure solution. Using several openings and several modifying elements behind them a delayed effect can be created, modifying elements can “pop out” after one another, and if several openings are made above one another and there are several modifying elements behind them the experience of vertical movement can also be created.

On the basis of the above recognitions we realise the set task with the help of advertising-provision equipment that has an advertising board positioned near a busy place containing advertising elements, especially text and/or picture(s), in front of and/or behind which there are modifying elements positioned at a distance, creating an impression of movement from the point of view of the person moving towards the advertising board and for him/her, being made visible and/or covered partly or completely by the advertising board, and characteristic of the equipment is that the advertising board contains an opening or openings, supplied in a given case with a transparent and/or translucent insert element, behind which there is(are) modifying a element(s) that are perceived to disappear and/or appear by an approaching person. It is advantageous if the cut-out(s) is(are) formed in the shape of an advertising element, for example a human face or product/commercial device, for example bottle, tube or similar form, or supplementary part of it. According to another construction example the modifying element contains fields of differing colours; in this case it may be practical if among the colour-fields, advantageously vertical bands, there are one or more black fields and if the fields positioned next to each other are of differing colours and if the advertising board has an opening-group consisting of numerous, relatively small sized openings, advantageously spreading over the whole surface area of the advertising board. According to another invention criterion the openings have regular geometric shapes, for example square shaped, circular, or multisided; and/or are formed into a concrete shape, for example a human eye, a bottle, a tube or a similar shape.

The subject of the invention also includes the equipment for providing advertisements, especially advertisements near public roads, that has an advertising board positioned near a busy place containing advertising elements, especially text and/or picture(s), in front of and/or behind which there are modifying elements positioned at a distance, creating an impression of movement from the point of view of the person moving towards the advertising board and for him/her, being made visible and/or covered partly or completely by the advertising board, and characteristic of the equipment is that at least one modifying element best placed in front of the advertising board a distance away from it contains an opening, in a given case with a transparent and/or translucent insert element; and on the advertising board from the point of view of a person travelling in a busy place towards it there are advertising elements, for example text, letters, designs and similar that create the impression of movement for the person looking through the opening(s) on the partly or completely free and/or covered part of the advertising board.

A different embodiment of the invention has an advertising board positioned near a busy place containing advertising elements, especially text and/or picture(s), in front of and/or behind which there are modifying elements positioned at a distance, creating an impression of movement from the point of view of the person moving towards the advertising board and for him/her, being made visible and/or covered partly or completely by the advertising board, and the essence of this equipment is that in the interest of creating the impression of vertical movement for a person approaching the advertising board, there are several openings formed in the advertising board, containing transparent or translucent inserts in a given case, and behind these, at a distance, there are several modifying elements that appear and disappear in the individual openings during the approach of the aforementioned person positioned at different heights; and/or in the advertising board there are one or more, for example, thin, longish rectangular openings extending in the vertical sense, and behind the opening(s) at a distance from the advertising board there is(are) a modifying element(s) that create the impression of vertical movement for the person and from the point of view of the person approaching the advertising board looking through the opening(s). It is practical if the modifying element is a board in the shape of a right-angled triangle with an angled edge, one of the small sides of which triangle is set to the appropriate side, and the lower end point of its small side is in the same line of or near to one of the lower corner points of the rectangular advertising board.

Finally, the subject of the invention forms the equipment which has an advertising board positioned near a busy place containing advertising elements, especially text and/or picture(s), in front of and/or behind which there are modifying elements positioned at a distance, creating an impression of movement from the point of view of the person moving towards the advertising board and for him/her, being made visible and/or covered partly or completely by the advertising board, and the essence of this equipment is that in one or more of the edges of the advertising board, especially in the upper edge there is(are) an opening(s) opening outwards, the modifying element(s) at a distance behind and/or in front of the advertising board are positioned in the region of this (these) edge(s). It is practical if the openings are formed in the upper edge of the advertising board in the form of, practically regular, waveforms consisting of peaks and troughs, and the one or more modifying elements positioned behind the advertising board in the region of the height of the openings is(are) a figure(s) expressing an activity associated with the waves, for example a surfer, and/or a boat or similar thing.

In the following the invention is described in detail on the basis of the attached drawings, which contain some advantageous construction examples of the equipment. On the drawings

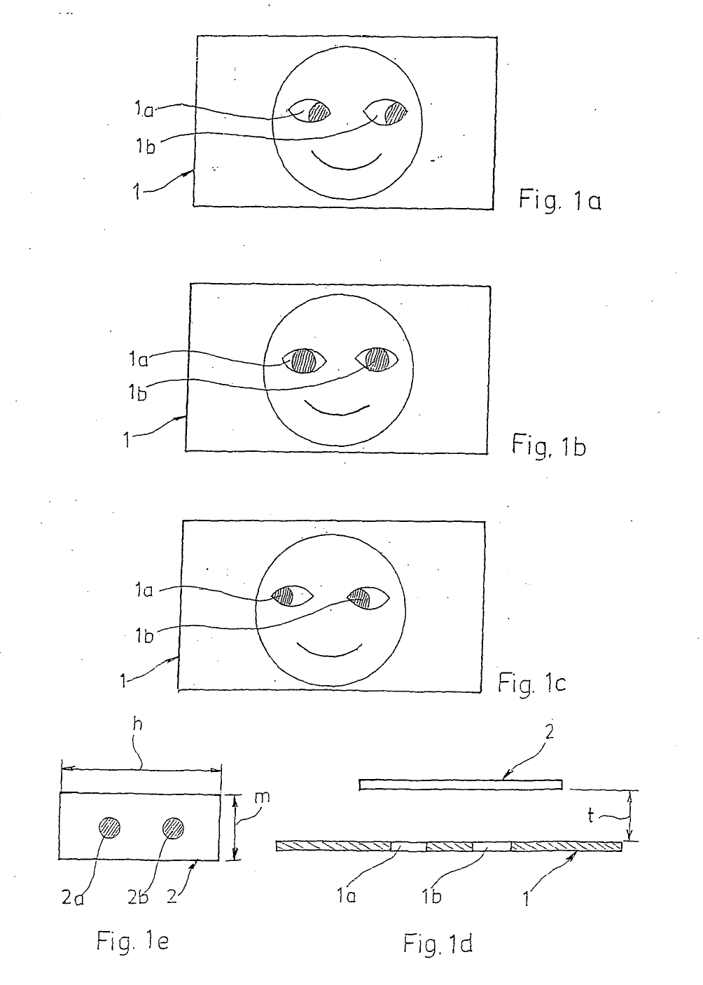

FIGS. 1a-1c show a construction form of the equipment in front view illustrating three phases of the facial expression of an advertisement figure;

FIG. 1d is the cross-section taken in the A-A line marked on FIG. 1a;

FIG. 1e is the modifying element visible in FIG. 1d in front view;

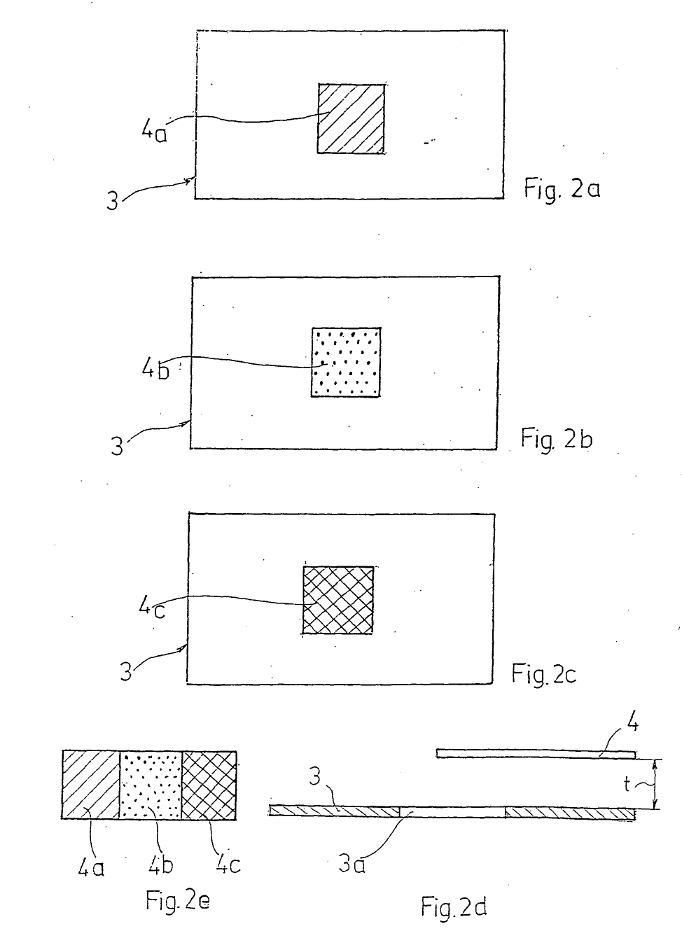

FIGS. 2a-2c show the front view of three colours one after the other of another construction form of the equipment;

FIG. 2d is the cross-section taken in the B-B line marked on FIG. 2a;

FIG. 2e is the front view of the modifying element visible on FIG. 2d;

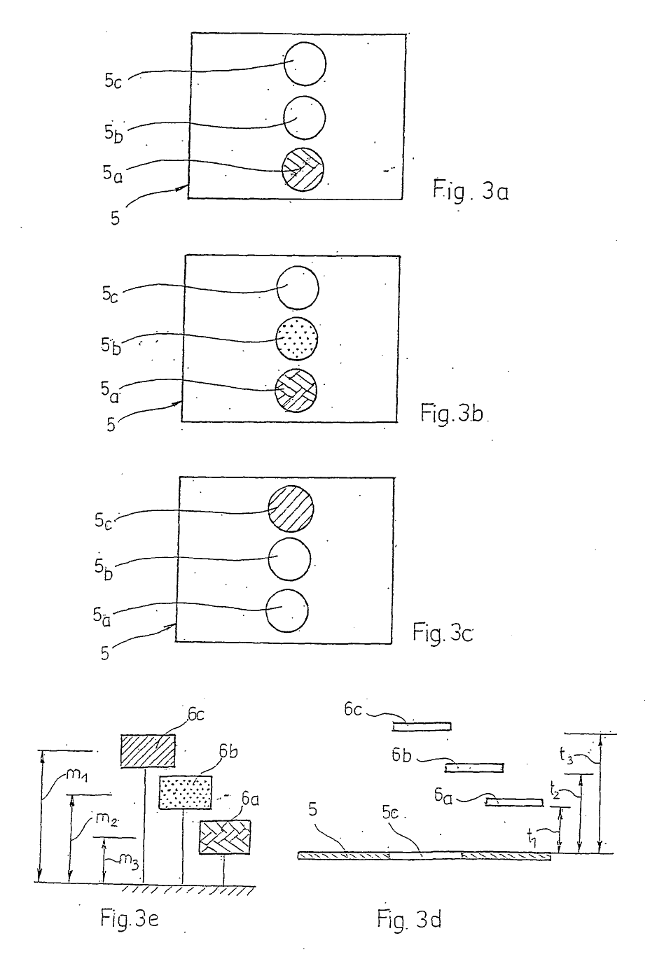

FIGS. 3a-3c show the front view of a further construction form of the equipment displaying different colours one after the other creating the sense of virtual vertical movement, also providing a sense of the individual phases of the movement;

FIG. 3e is the front view of the modifying elements;

FIG. 3d is the cross-section taken in the C-C line marked on FIG. 3a,

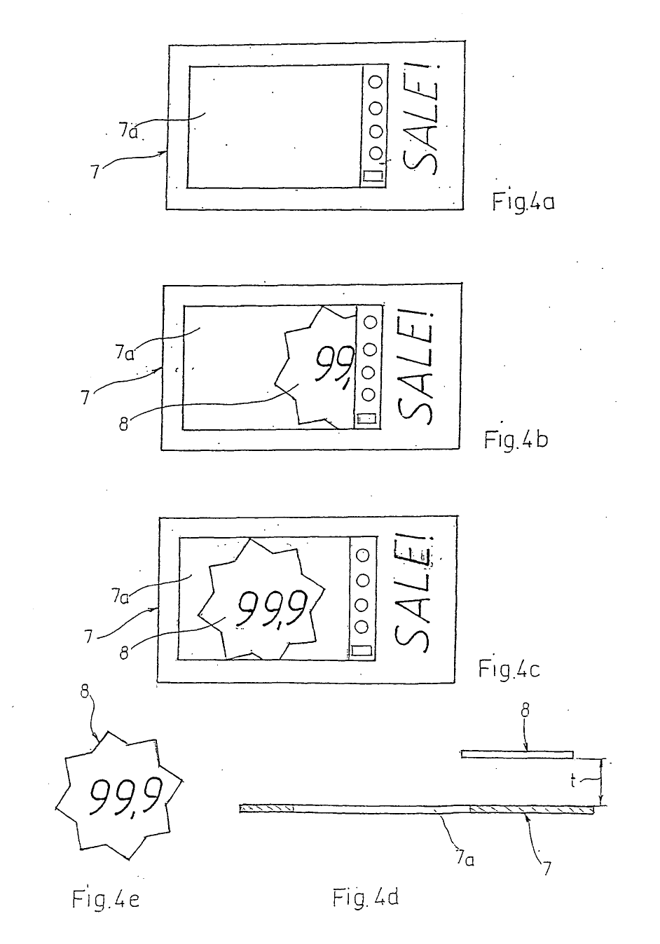

FIGS. 4a-4c illustrate another construction form of the equipment in movement phases similar to the previous ones;

FIG. 4d is the cross-section taken in the F-F line marked on FIG. 4a;

FIG. 4e shows the front view of the modifying element according to FIG. 4d;

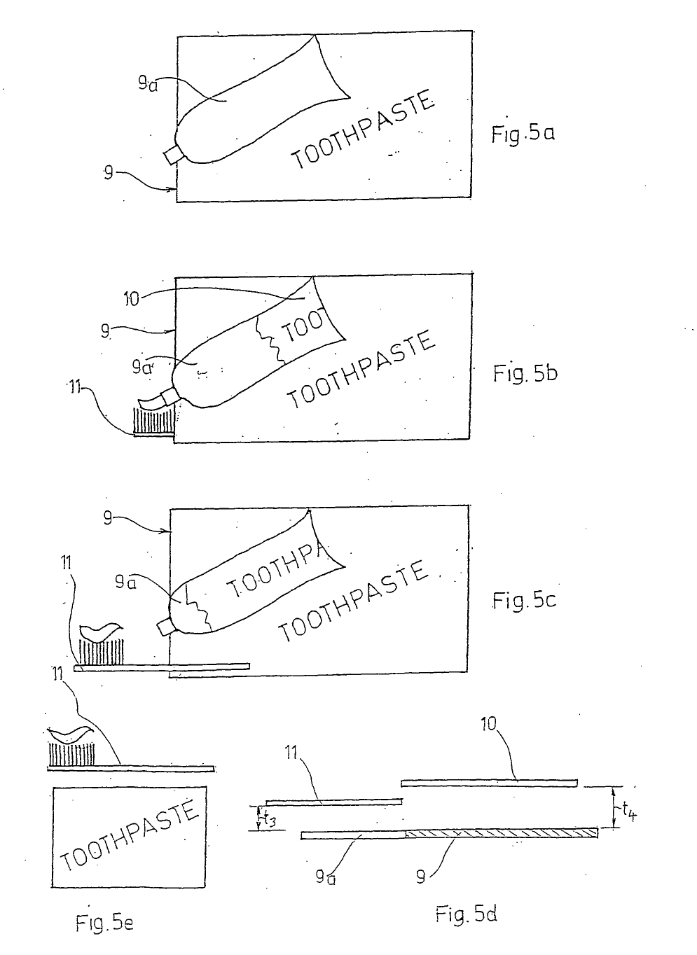

FIGS. 5a-5c show a further construction form of the equipment using two modifying elements of differing function in front view showing the three movement phases;

FIG. 5d is the cross-section of the equipment according to FIGS. 5a-5c taken in the G-G line marked on FIG. 5a;

FIG. 5e shows the front view of the modifying elements belonging to the equipment according to FIGS. 5a-5c;

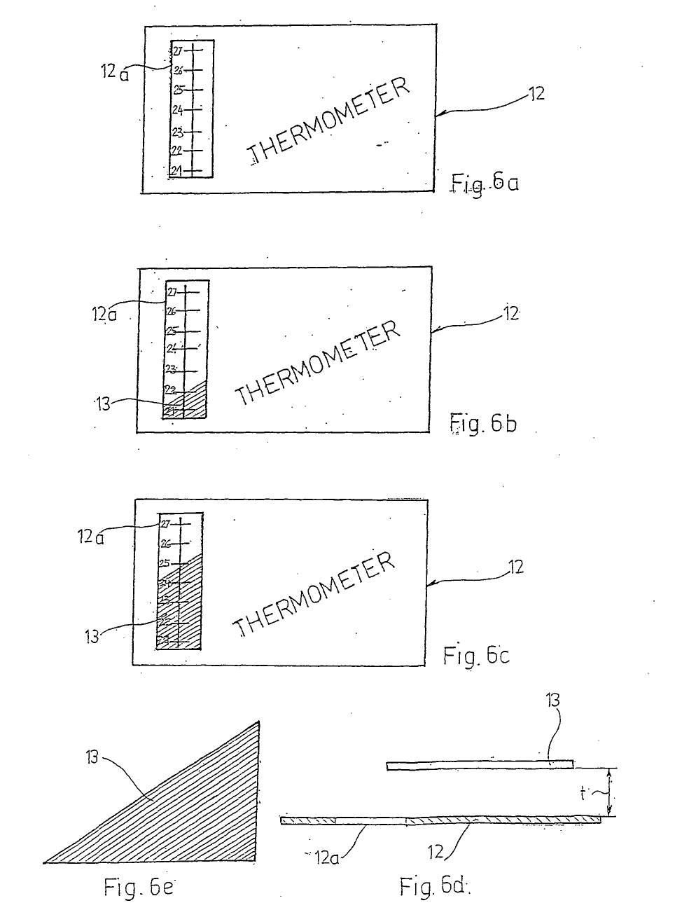

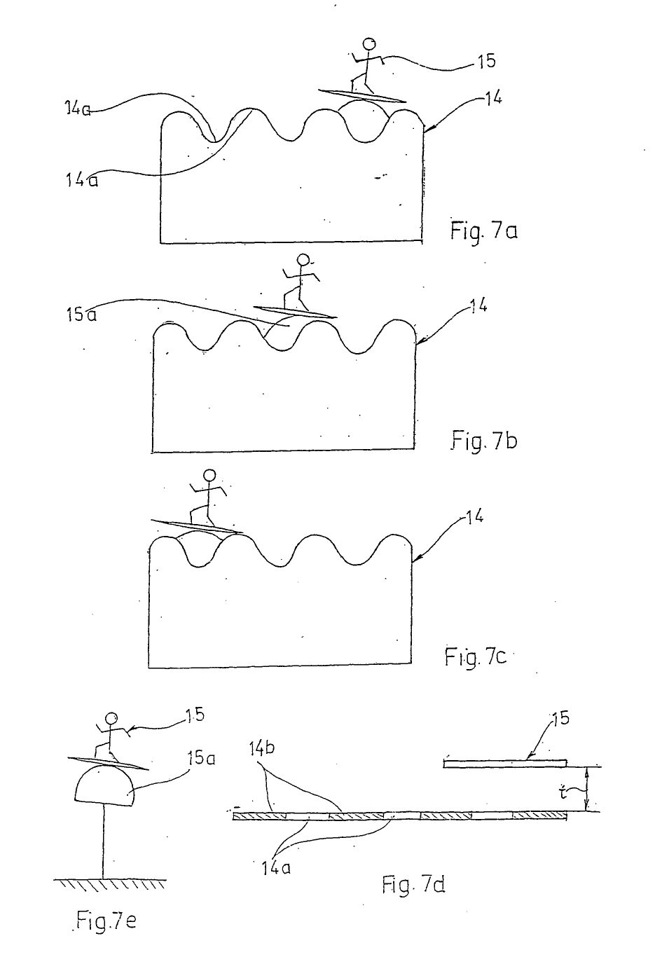

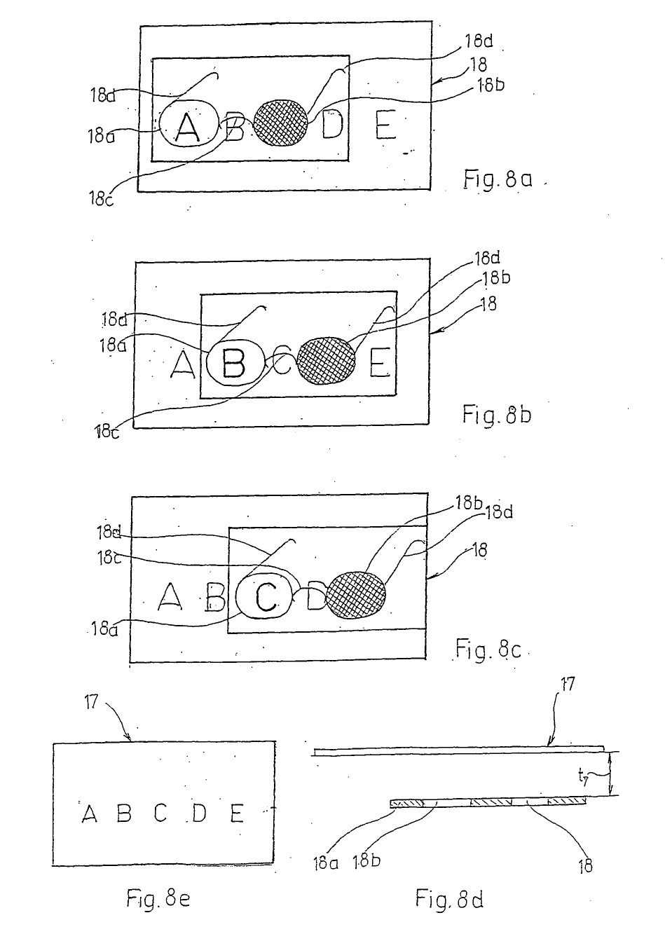

FIGS. 6a-6c show the front view of advertising-providing equipment depicted in a system similar to the above;

FIG. 6d is the cross-section taken in the H-H line marked on FIG. 6a;

FIG. 6e is the top view of the modifying element that forms a part of the equipment according to FIG. 6d;

FIGS. 7a-7c show a construction example of the equipment according to the invention where the openings are formed as the peaks and troughs of waves on the upper edge of the advertising board;

FIG. 7d is the cross-section taken in the K-K line marked on FIG. 7a;

FIG. 7e shows the modifying element according to FIG. 7d in front view;

FIGS. 8a-8c show a construction form of the equipment in front view in which the modifying element positioned in front of the advertising board contains openings;

FIG. 8d is the horizontal cross-section taken in the L-L line marked on FIG. 8a;

FIG. 8e shows the advertising board in front view;

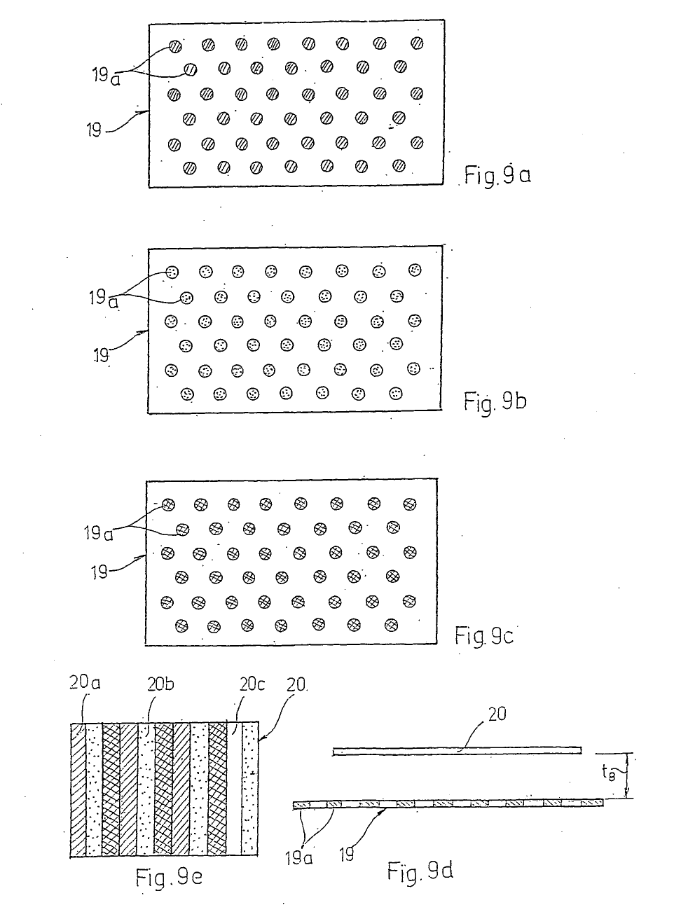

FIGS. 9a-9c show a construction form of the equipment according to the invention in which the advertising board contains numerous small openings, holes, while the modifying element behind it has bands of differing colours;

FIG. 9d is the cross-section taken in the M-M line marked on FIG. 9a;

FIG. 9e shows the modifying element in top view.

The advertising board of height M and width h₁ of the equipment visible on FIGS. 1a-1e has two oval openings, cut-outs, in the places on a stylised person's face drawing where the eyes should be. Behind the advertising board 1, from the point of view of the observer approaching the board, there is a modifying element 2 also formed by a board at a distance t at the height of the cut-outs 1a, 1b, it is of a smaller size than the advertising board 1, width h₂ and height m, and the markings 2a, 2b on this (black patches on a white background) form the pupils. As the person approaching-observing the plane of the otherwise parallel advertising board 1 and modifying element 2 does so at an angle that is not perpendicular to it, he/she sees through the openings 1a, 1b and senses that the eyes of the figure on the advertising board 1 move, with the look as if they continuously follow the person approaching them. Naturally in order to create this effect the distance t has to be selected to be appropriately small, a few metres for example, but it is not advisable to reduce the distance t to under 1.0 m, because in the case of too small a distance t the relative movement, in practice, can not be sensed, and if it is too large it has no effect, or can not be noticed. These determinations, naturally, relate to all the construction examples that are to be described henceforward and as a consequence to the general solution according to the invention as well.

Also in the case of the equipment according to FIGS. 2a-2e the modifying element 4 is positioned behind the advertising board 3 at a distance t, parallel to it and covered by it, which modifying element 4 is at least as high as the opening in the advertising board 3 that has a relatively large, square opening 3a in the middle and extends from the one side edge of this opening towards the other edge, and extends to at least the edge of the advertising board 3.

The modifying element 4 has three fields 4a, 4b and 4c of differing colour; field 4a for example is red, 4b white and 4c green. So then if the observer approaches the equipment from the side, not perpendicular to the advertising board, they appear one after the other, three different colours appear in the centre of the advertising board 3. Naturally the advertising board 3 can also even contain several other types of advertising element (text, picture, etc.). It is also obvious that the modifying element 4 may also contain more than three colours.

The construction form of the equipment according to FIG. 3 makes it possible to sense vertical movement for a person approaching it from the side. In the interest of this behind the advertising board 5 containing the round openings 5a, 5b and 5c positioned above one another there are three different advertising boards 6a, 6b and 6c, at different heights from the ground level T (FIG. 3e) m₁, m₂ and m₃ in accordance with the openings 5a-5c, which are positioned displaced from one another in the lateral direction and at differing distances t₁, t₂ and t₃ from the advertising board 5. As a consequence of the arrangement described above, as the sensing of the relative movement of the modifying elements 6a-6c does not take place at the same time, they also appear in the openings 5a-5c after one another. The arrangement according to FIGS. 3a-3e embodies a set of traffic lights (beside which the advertising board 5 may also obviously contain other advertising elements). In accordance with this the person approaching the equipment as a consequence of the arrangement according to FIG. 3a first senses that the lower opening 5a is filled with the colour green, while the openings 5b and 5c are empty; then in accordance with FIG. 3b the opening 5a is filled with the colour green and the opening 5b with the colour yellow, while the opening 5c is empty; finally in the state according to FIG. 3c the upper opening 5c is filled with the colour red, while the openings 5a and 5b are empty. Depending on the positions of the e.g. public road (not shown) and the advertising equipment as compared to each other the position of the modifying elements 6a-6c can be precisely determined so that the whole equipment, as the modifying elements 6a-6c “slide in” and “slide out of” the openings 5a-5c, has the effect on a observer approaching it of the operation of a set of traffic lights.

The equipment according to FIGS. 4a-4e is for advertising the price of a television set (99.9). On the advertising board 7 there is a single large opening 7a, beside which the television operating buttons and the sign “SALE” are shown. The modifying element 8, a board, positioned behind the advertising board 7 at a distance t is star-shaped, and has the figure “99.9” painted on it showing the price, which, as the observer progresses towards the equipment, slowly “slips” into the centre of the opening 7a, and together with star becomes completely visible.

The equipment to be seen on FIGS. 5a-5e is for the advertising of a type of toothpaste, and in this case the advertising board 9 containing a tube-shaped opening 9a has two modifying elements 10, 11, which are arranged behind the advertising board 9 at different distances t₃, t₄. Bother the advertising board 9 and the modifying element 10 contain the text “TOOTHPASTE”, the former horizontally along its lower edge and the latter at an angle (this is in actual fact the brand name of a certain toothpaste). As a consequence of the arrangement according to FIG. 5d of the advertising board 9 and the modifying elements 10, 11 a person approaching the equipment senses two types of movement: on the one hand the sign “TOOTHPASTE” appears in the opening and on the other hand the modifying element 11 in the shape of a toothbrush at the bottom of the advertising board 9 with a piece of toothpaste on it under the mouth of the tube seems to “pop out” creating the impression that a portion of toothpaste has been pushed out of the tube.

Also with the equipment according to FIGS. 6a-6e the sense of vertical movement can be created, however, in this case not with several modifying elements (three in the case of FIG. 3a-3e) but with only one suitably formed modifying element 13, which is positioned behind the advertising board 12 at a distance t₅, in parallel with it. There is a gap-like vertical opening 12a in the advertising board 12, beside which a thermometer scale and to the right of the opening 12a the text “THERMOMETER” can be seen (which may contain a symbol or a concrete brand name instead, and the advertising board 12 in this case may also contain other advertising elements). As it can be seen on FIG. 6e, the modifying element 13 here is a board in the shape of a right-angled triangle, which is of the same length as the advertising board 12, and the lower point of its diagonal is in the same line as one of the lower corner points, here the left, of the advertising board 12. As the observer approaches the equipment as a consequence of the relative movement of the boards, he/she senses as if the mercury in the thermometer is going upwards, in other words as if the temperature were rising.

In the case of the equipment according to FIGS. 7a-7d there are openings 14a formed in the upper edge of the longish, rectangular advertising board 14, in this case the openings are not closed but open upwards, and they are each enclosed by two ribs. The openings 14a are cut-outs that become narrower towards the bottom with a curved contour, in accordance with this the ribs 14b are also obviously of this shape, so the upper contour of the advertising board 14 is a wave line, in this case as the openings 14a and the ribs 14b are of the same shape and size it is regular, a sine wave, so the ribs 14b appear as wave peaks and the openings 14a as wave troughs. Behind the advertising board at a distance t₆ there is a modifying element 15 containing a surfer figure standing on a surfboard on the top of a large wave 15a at the height of the openings 14a, in other words at the height of the wave line. A person approaching the equipment from the side senses as if a surfer on the top of the large wave 15a moved from the left to the right on the surface of the wavy water according to FIGS. 7a-7c.

On FIGS. 8a-8c there is advertisement-providing equipment advertising glasses the modifying element 18 of which is positioned in front of the advertising board at a distance t₇ and contains circular, openings 18a, 18b, acting as the lenses of the glasses, which are positioned separated from each other by a distance in the lateral direction 1, and the modifying element 18, board, is supplemented by a nose-bridge curve 18c and glasses arms 18d painted onto the flat surface in an imitation of a pair of spectacles. As it can be seen only on FIG. 8e, for clarity reasons, there is a series of letters consisting of ABCDEF applied to the advertising board 17 (beside the name or emblem, etc. of a glasses manufacturing company for example, not shown), in the line of the openings 18a, 18b, of which the left opening 18a is of completely transparent material, e.g. an insert made of water-clear perspex, while in the right opening 18b there is an insert that has a light-distortion characteristic, e.g. thick perspex, which distorts the picture, the letter behind it, so it appears to the observer in bad quality, out of focus, just as a person with bad eyesight sees.

Finally the advertising board 19 of the advertising equipment according to FIGS. 19a-19e is pierced by small but a large number of openings 19a, while the modifying element 20, board, positioned behind and parallel to it at a distance t₈ has vertical, coloured bands 20a-20d on it. The openings 19a, holes, on the advertising board 19a may be positioned in a regular distribution, e.g. with the same lateral distance between them, in lines, but they may also be distributed in other configurations, even irregularly. It is practical to select the colours of the bands 20a-20d, e.g. red, white, black, green, etc., so that the neighbouring bands 20a-20b, 20c-20d, etc. are of different colours. For a person approaching the equipment from the side the colours appear in the openings 19a flashing one after the other, as if they were “switching on and switching off”, as at least one band, or more on the modifying element 20 is black. So fireworks, explosions, starry skies, bubbles can be displayed on the advertising board 19, which can very effectively increase the effectiveness of the actual (not shown) advertising text or design.

The advantage of the invention is that for a small investment it very intensively increases the effectiveness, variation and attention-grabbing characteristics of the advertisement.

The invention is not restricted to the construction examples of the equipment described in detail above, it may be implemented in several ways within the area of protection defined in the claims.

1. Equipment for providing advertisements, especially advertisements alongside public roads, that has an advertising board positioned near a busy place containing advertising element(s), especially text and/or picture(s), in front of and/or behind which there are modifying elements positioned at a distance, creating an impression of movement from the point of view of the person moving towards the advertising board (7; 9;) and for him/her, being made visible and/or covered partly or completely by the advertising board, characterised by that the advertising board (1; 3; 7; 9; 19) contains an opening or openings (1a; 1b; 3a; 7a; 9a; 19a), supplied in a given case with a transparent and/or translucent insert element, behind which there is(are) modifying a element(s) (2; 4; 8; 10; 20) that are perceived to disappear and/or appear by an approaching person.

2. The equipment according to claim 1 characterised by that the cut-out(s) (1a; 1b; 9a) is(are) formed in the shape of an advertising element, for example a human face or product/commercial device, for example bottle, tube or similar form, or supplementary part of it.

3. The equipment according to claim 1 or 2 characterised by that the modifying element (4; 20) contains fields (4a-4c; 20a-20d) of differing colours.

4. The equipment according to claim 3 characterised by that among the colour-fields (20a-20d), advantageously vertical bands, there are one or more black fields and the fields positioned next to each other are of differing colours and the advertising board (19) has an opening-group consisting of numerous, relatively small sized openings (19a), advantageously spreading over the whole surface area of the advertising board (19).

5. The equipment according to any of claims 1-4 characterised by that the openings (3; 19a) have regular geometric shapes, for example square shaped, circular, or multisided; and/or are formed into a concrete shape, for example a human eye, a bottle, a tube or a similar shape.

6. Equipment for providing advertisements, especially advertisements near public roads, that has an advertising board positioned near a busy place containing advertising elements, especially text and/or picture(s), in front of and/or behind which there are modifying elements positioned at a distance, creating an impression of movement from the point of view of the person moving towards the advertising board and for him/her, being made visible and/or covered partly or completely by the advertising board characterised by that at least one modifying element (18) best placed in front of the advertising board (16) a distance (t₇) away from it contains an opening, in a given case with a transparent and/or translucent insert element; and on the advertising board (16) from the point of view of a person travelling in a busy place towards it there are advertising elements, for example text, letters, designs and similar that create the impression of movement for the person looking through the opening(s) (18a, 18b) on the partly or completely free and/or covered part of the advertising board (16).

7. Equipment for providing advertisements, especially advertisements near public roads, that has an advertising board positioned near a busy place containing advertising elements, especially text and/or picture(s), in front of and/or behind which there are modifying elements positioned at a distance, creating an impression of movement from the point of view of the person moving towards the advertising board and for him/her, being made visible and/or covered partly or completely by the advertising board characterised by that in the interest of creating the impression of vertical movement for a person approaching the advertising board (5; 12), there are several openings (5a-5c) formed in the advertising board (5; 12), containing transparent or translucent inserts in a given case, and behind these, at a distance (t₁-t₃), there are several modifying elements (6a-6c) that appear and disappear in the individual openings (5a-5c) during the approach of the aforementioned person positioned at different heights (m₁-m₃); and/or in the advertising board (12) there are one or more, for example, thin, longish rectangular openings (12a) extending in the vertical sense, and behind the opening(s) (12a) at a distance (t₅) from the advertising board (12) there is(are) a modifying element(s) (13) that create the impression of vertical movement for the person and from the point of view of the person approaching the advertising board (12) looking through the opening(s) (12a).

8. The equipment according to claim 7 characterised by that the modifying element (13) is a board in the shape of a right-angled triangle with an angled edge, one of the small sides of which triangle is set to the appropriate side, and the lower end point of its small side is in the same line of or near to one of the lower corner points of the, for example, rectangular advertising board (12).

9. Equipment for providing advertisements, especially advertisements near public roads, that has an advertising board positioned near a busy place containing advertising elements, especially text and/or picture(s), in front of and/or behind which there are modifying elements positioned at a distance, creating an impression of movement from the point of view of the person moving towards the advertising board and for him/her, being made visible and/or covered partly or completely by the advertising board characterised by that in one or more of the edges of the advertising board (14), especially in the upper edge there is(are) an opening(s) (14a) opening outwards, the modifying element(s) (15) at a distance (t₆) behind and/or in front of the advertising board (14) are positioned in the region of this (these) edge(s).

10. The equipment according to claim 9 characterised by that the openings (14a) are formed in the upper edge of the advertising board (14) in the form of, practically regular, waveforms consisting of peaks and troughs, and the one or more modifying elements (15) positioned behind the advertising board (14) in the region of the height of the openings (14a) is(are) a figure(s) expressing an activity associated with the waves, for example a surfer, and/or a boat or similar thing.
